(19) United States
(12) Patent Application Publication
(10) Pub. No.: US 2017/0337793 A1
(43) Pub. Date: Nov. 23, 2017

(54) NOVEL BUILDING AUTOMATION

(71) Applicant: iHaus AG, Unterfoehring (DE)

(72) Inventor: Robert Klug, Munich (DE)

(21) Appl. No.: 15/497,410

(22) Filed: Apr. 26, 2017

Related U.S. Application Data
(63) Continuation of application No. PCT/EP2015/002136, filed on Oct. 28, 2015.

(30) Foreign Application Priority Data
Oct. 29, 2014 (DE) 102014015902.7
Oct. 29, 2014 (DE) 202014008556.0
Nov. 21, 2014 (DE) 102014017187.6
Nov. 21, 2014 (DE) 202014009243.5

(51) Int. Cl. G08B 19/00; G08B 25/14; G05B 19/02; G05B 15/02; G08B 13/196; H04L 12/28; G08B 17/10

(52) U.S. Cl. CPC G08B 19/005; H04L 12/2803; G08B 25/14; G08B 17/10; G05B 15/02; G08B 13/196; G05B 19/02; G05B 2219/2642

(57) ABSTRACT

The invention relates to a system for building automation including at least one smoke and/or fire detector, at least one adapter that is coupleable with the smoke or fire detector; and one or plural functional units which are connected or connectable with the adapter. The building also relates to a building automation method.

### RELATED APPLICATIONS

This application is a continuation of International application PCT/EP2015/002136 filed on Oct. 28, 2015 and claiming priority from German patent applications
DE 10 2014 015 902.7, filed on Oct. 29, 2014,
DE 20 2014 008 556.0, filed on Oct. 29, 2014,
DE 10 2014 017 187.6, filed on Nov. 21 2014, and
DE 20 2014 009 243.5, filed on Nov. 21, 2014.

### FIELD OF THE INVENTION

The invention relates to a system for building automation according to the preamble of claim 1 and a method for building automation according to the preamble of claim 14.

### BACKGROUND OF THE INVENTION

Recently building automation, thus an entirety of monitoring, control and optimization devices, in particular building automation, thus an increase of living comfort for inhabitants of private buildings is considered more and more relevant. Considerable efforts are being made to provide suitable solutions, wherein it is an object to include as many pieces of equipment and similar building elements in a common network in order to be able to jointly control the building elements.

### BRIEF SUMMARY OF THE INVENTION

Thus it is an object of the invention to further improve building automation.

The object is achieved by a system for building automation including at least one smoke or fire detector including a connection side; at least one adapter that is coupleable with the at least one smoke or fire detector and that includes a front side, a backside and a lateral portion connecting the front side and the backside; and at least one functional unit which is connected or connectable with the at least one adapter, wherein the at least one smoke or fire detector is arranged with the connection side on a front side of the at least one adapter and the at least one functional unit extends with respect to the connection side of the at least one smoke or fire detector below the at least one smoke or fire detector about the lateral portion of the at least one adapter in a connected condition of the at least one smoke or fire detector, the at least one adapter and the at least one functional unit, and wherein the at least one smoke or fire detector, the at least one adapter and the at least one functional unit are mechanically connected in the connected condition of the at least one smoke or fire detector, the at least one adapter and the at least one functional unit.

The object is also achieved by a method for building automation, wherein at least one smoke or fire detector that includes a connection side is coupled with at least one adapter that includes a front side, a backside and a lateral portion connecting the front side and the backside, so that the connection side of the at least one smoke or fire detector is arranged on the front side of the at least one adapter, and wherein the at least one functional unit is being connected with the at least one adapter so that the at least one functional unit extends with respect to the connection side of the at least one smoke or fire detector below the at least one smoke or fire detector about the lateral portion of the at least one adapter in a connected condition of the at least one functional unit, the at least one smoke or fire detector and the at least one adapter, wherein the at least one functional unit, the at least one smoke or fire detector and the at least one adapter are mechanically connected in the connected condition of the at least one functional unit, the at least one smoke or fire detector and the at least one adapter.

Advantageous embodiments are provided in the dependent claims.

The inventors have found that the object can be achieved in a particular simple and effective manner by improving upon smoke or fire detectors typically already provided in buildings and expanding their functionality. Thus, no additional installation space is required but the space required for the smoke and fire detectors is used in an optimum manner which benefits overall esthetics of the building.

Accordingly the building automation system according to the invention includes at least one smoke and/or fire detector, at least one adapter which is coupleable with the smoke or fire detector and one or more functional units that are connected or connectable with the adapter. For example a typical smoke detector can be supplemented by illumination devices and/or motion detectors.

The functional units can thus either be integrated in the adapter or connectable with the adapter. Thus the connection can be provided mechanically and/or for data transfer and/or for energy transfer directly with the adapter or also indirectly, this means with one or plural other devices connected there between.

In this context “connecting” or “connection” does not only mean mechanical or data connections but also relates to a direct process of transferring information or parameters.

A mechanical and/or communicative and/or energetic connection with the smoke and fire detector can thus be provided but is not required for the instant invention since advantageous effects can also be achieved without this connection.

The adapter can merely thus merely be a mechanical adapter or also an adapter with an energy and/or communication interface to the smoke and fire detector.

In this context it is advantageous when at least a second adapter is provided which is adapted to provide a second interface for the functional unit or other house hold equipment. Thus an adaptation to any type of smoke or fire detector and functional unit and household equipment can be provided in a particularly simple and cost effective manner, since the interfaces of smoke and fire detectors and household equipment are typically provided as proprietary interfaces.

In an advantageous embodiment the one or plural functional units are provided as modules. Then the functional scope of the smoke and fire detectors can be expanded particularly easily.

A particularly advantageous embodiment of the functionality is provided when the functional unit implements one or plural properties from the group motion detector, temperature sensor, video capture, audio capture, illumination, brightness sensor, humidity sensor, CO₂ sensor, CO sensor and similar.

Advantageously a first control and/or processing device is provided which is advantageous provided as the adapter. Then the expanded functional scope can be used in a more comprehensive manner. Furthermore no additional central control and processing devices are required which further reduces space requirement.

It is particularly useful in this context when the first control and/or processing device
a) controls the smoke or fire detector and/or the functional unit, and/or
b) reads out at least one property of the smoke and fire detector and/or of the functional unit.

The adapter is advantageous provided as a communication device, in particular as a gateway.

When at least a data connection is provided with at least one piece of household equipment advantageously from the group including automatic door opener, illumination device, motion detector, vehicles, television sets, freezers, dish cleaners, heating systems, stoves, coffee makers, fire places, air conditioners, stove tops, refrigerators, microwaves, blenders, music play back devices, smoke and fire detectors, radios, lawn irrigation systems, cleaning devices, bathroom equipment, saunas, locks, umbrellas, sprinkler systems, vacuum cleaners, swimming pools, monitoring devices, blinds, washers, dryers, water heaters, meteorological stations, whirlpools and similar then linking plural building elements described in the application “Method and system for building automation” owned by Applicant and filed on Nov. 21, 2014 can be implemented in a particularly simple manner. The content of this application is incorporated by reference so that smoke and fire detectors, functional units and the household equipment recited supra are “building elements”.

“Building elements” are thus not only pieces of equipment that are permanently connected to the building but also equipment that is mobile and only located in the building temporarily. Thus, a building is not only a house or a similar object but also a plot of land and improvements that are associated with the object.

In another advantageous embodiment it is provided that the first control and/or processing device is adapted to collect and/or process information from connected pieces of household equipment, the smoke and fire detector, and/or the functional unit and/or to forward the information to at least one second control and/or processing device.

It is particularly advantageous when the functional unit is configured coupleable to the first control and/or processing device and/or the adapter. This is a data connection and/or energy connection where no direct access to the smoke or fire detector is performed.

It is furthermore advantageous when the functional unit extends in connected condition about the first control and/or processing device and/or the adapter, wherein the functional unit is advantageously configured circular ring shaped. This embodiment facilitates a particularly esthetic appearance. Furthermore the smoke and fire detector remains compact. Furthermore the functionality can be expended in a particularly simple manner without interfering with the function and safety requirements of the smoke and fire detector.

In another embodiment it is provided that plural functional units are configured pluggable into each other and/or that the functional unit includes a base element into which modules implementing one or plural properties are pluggable. This facilitates an uncomplicated and expandable configuration of the functionality. Thus, the functional units can mesh with each other wherein the functional units are configured e.g. as ring elements with meshing teething which provide a mechanical clip function.

Integrating and augmenting the building automation system is performed in a very simple manner when the first control and/or processing device is associated with an address that is associable in a unique manner in a communication network, wherein the address is in particular a MAC-address in an IP network.

This is also facilitated in that the first control and/or processing device includes a network interface to provide communication with additional network units, advantageously with a second control and/or processing device, wherein the network interface is based in particular on at least one protocol from the group blue tooth, Wi-Fi, ZigBee, Z-Wave, Ethernet, WLAN and similar. Then communications are provided in a particularly simple and safe manner.

Another advantageous embodiment provides that

a) the first control or processing device and/or the adapter is autonomously provided with energy for implementing a minimal mode using at least one energy supply from the group including battery, accumulator and solar module in order to read out at least one property of a connected device in order to monitor the device and to forward respective errors to a provided error reporting unit, and/or that

b) the first control or processing device, and/or the adapter is provided with external energy for implementing a maximum mode, for example by PoE (power over Ethernet), Mini-USB interface or 110-220 V supply.

In both cases a loading of the energy supply of the smoke or fire detector that is to be permanently provided for safety reasons is effectively avoided. Furthermore it can also be provided that the smoke or fire detector is provided with energy through the first control and processing device and/or the adapter. This can also be provided in addition to a regular energy supply of the smoke or fire detector.

For safety reasons an external power supply for an energy intense functional unit, like e.g. illuminant or for a ZigBee interface can be provided. For example the adapter can be provided with a corresponding external power supply in order to cover the energy requirement. This adapter can then also provide e.g. the smoke detector with energy.

For smoke and fire detectors, however also other safety aspects have to be considered. Thus, for example no external heat introduction may be performed by the lighting system in order not to impair its function. Therefore the functional unit configured for lighting shall be provided with low load LEDs and a direct light radiation onto the smoke detector shall be prevented.

When the smoke and fire detector is data connected it can be provided for example that in addition to its standard alarm tone the following is provided:

1. lights turn on, flash or change color upon an alarm, and/or

2. a public announcement instructing everybody what to do and not only a siren sounds upon an alarm and/or

3. A video image of the room is captured upon an alarm,

Independent patent protection is also claimed for the method according to the invention for building automation, wherein at least one smoke and/or fire detector is coupled with at least one adapter, wherein one or more functional units are connected with the first adapter or are going to be connected with the first adapter.

Advantageously the building automation system according to the invention is used for the method.

According to the invention features of the system can be used as features for the method and features of the method can also be used as features for the system when nothing else is stated.

Furthermore unless stated differently all features can be combined with each other at will.

### BRIEF DESCRIPTION OF THE DRAWINGS

The invention is subsequently described in more detail with reference to an embodiment illustrated in a drawing figures. Further details of the invention can be derived from the subsequent description of the embodiments in combination with the patent claims and the appended drawing figures, wherein:

FIG. 1 illustrates the system according to the invention in an advantageous embodiment;

FIGS. 2A, 2B illustrates the smoke detector according to the invention with expanded functionality.

### DETAILED DESCRIPTION OF THE INVENTION

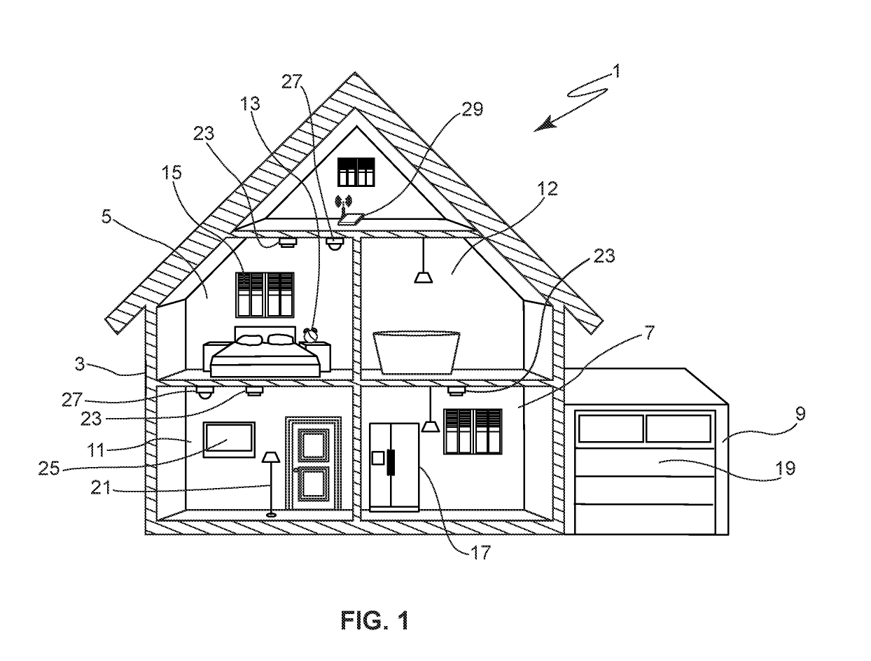

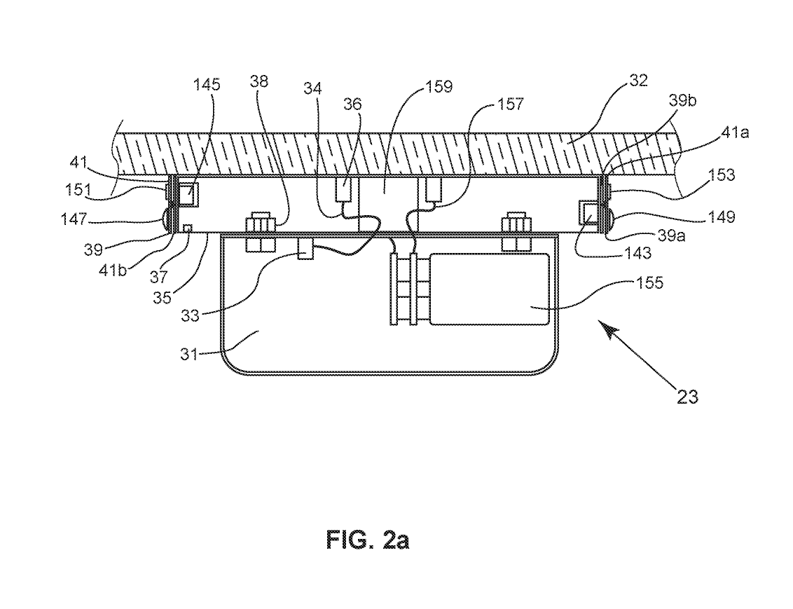

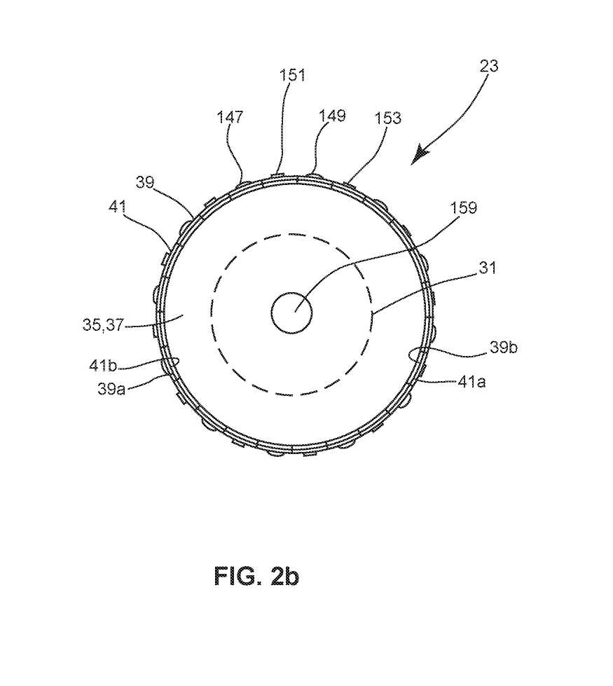

FIGS. 1-2B schematically illustrate the instant invention wherein FIG. 1 illustrates an advantageous embodiment of the system 1 according to the invention for building automation and FIGS. 2A and 2B illustrate a perspective view and a sectional view of the smoke detector 23 according to the invention with expanded functionality.

It is evident from FIG. 1 that the system 1 according to the invention for building automation according to an advantageous embodiment includes a building 3 configured as a residence which includes for example a bedroom 5, a kitchen 7, a garage 9, a living room 11 and a bathroom 12. The bedroom 5 includes an electronically controllable alarm clock 13 and an electronically controllable light restriction device 15 configured as an adjustable blind. In the kitchen 7 there is a refrigerator 17. The garage 9 includes an electronically controllable garage door 19 and the living room 11 includes a lamp 21, a smoke detector unit 23 and a television set 25. In all rooms 5, 7, 9, 12 furthermore presence detectors 27 for inhabitants (not illustrated) are arranged which are based for example on the iBeacon® technology by Apple Inc. Furthermore a telephone an Internet system, for example a Fritz® box 29 is provided and all of the building elements 13, 15, 17, 19, 21, 23 25, 27, 29 are linked with each other, wherein the network is can be provided wired or wireless, for example by WLAN. The network can be thus centrally operated by a special server or can be operated in a decentralized manner wherein the smoke detector unit 23 includes a proprietary server as will be demonstrated infra.

As an alternative to an electronically controllable alarm clock 13 also a system like SONOS® can be used which includes a series of wirelessly connected speakers which facilitates synchronous playback on all speakers or for example only on speakers which are arranged in rooms that are currently being used.

In this system 1 it is possible that individual building elements 13, 15, 17, 19, 21, 23, 25, 27, 29 display information from other building elements 13, 15, 17, 19, 21, 23, 25, 27, 29 and/or that building elements 13, 15, 17, 19, 21, 23, 25, 27, 29 are controlled or regulated by parameters which are provided by other building elements 13, 15, 17, 19, 21, 23, 25, 27, 29.

For example opening the garage door 19 by remote control from outside the house 3 can be used as a parameter to turn on the light 21. Or a malfunction of the garage door 19 which does not close is directly signaled on the television set 25 when the presence detector 27 determines that the inhabitant is in the living room 11. Or the non-function is indicated by a flashing or a color change of the lamp 21, wherein the inhabitant detects this from the type of this display or is encouraged by the signaling to inquire about the reason for the signaling on a computer device, e.g. a telephone or a tablet computer.

In FIG. 2A and 2B the smoke detector 23 unit illustrated in FIG. 1 is illustrated in more detail. It is evident that a modular configuration is provided wherein the smoke detector unit 23 includes a conventional smoke detector 31 which includes a communication interface 33. An adapter 35 is connected with this communication interface 33 through a communication cable 34 with a corresponding communication interface 36 wherein the adapter includes a device driver for the smoke detector 31 so that the smoke detector 31 can be integrated into the network of the system 1. For this purpose the adapter 35 includes suitable communication devices, for example a WLAN connection (not illustrated). The adapter 35 is furthermore connected with a control and/or processing device 37 which is configured as mini server. Thus, the adapter 35 and the mini server 37 are configured as one single module. The smoke detector unit is arranged at a room ceiling 32. FIG. 2B illustrates a sectional view from the side of the ceiling. It is evident that the typically provided attachment 38 of the smoke detector 31 is used for attaching the smoke detector 31 at the adapter 35. The adapter 35 itself is typically (not illustrated) screwed together or glued together with the ceiling 32.

Two functional units 39, 41 are arranged about the adapter 35 and the mini serve 37 wherein the two functional units are mechanically connected with each other and are provided with a data connection to the adapter 35. The functional units 39, 41 are plugged in around the adapter 35 and plugged into each other as evident in particular from FIG, 2B. For this purpose corresponding plug connectors 143, 145 are provided which provide communications to the adapter 35 as well as a voltage supply for the functional units 39, 41 Thus, the adapter 35 is also an adapter for the smoke detector 31 and also an adapter for the function units 39, 41 through the plug connections 143, 145.

At one functional unit 39 illuminants 137 and a module for receiving audio and video signals 149 are arranged, whereas a motion detector 151 and a temperature sensor 153 are arranged at the functional unit 41. The illuminants 147 are provided as low load LEDs which are not oriented directly towards the smoke detector 31. The temperature sensor 153 can be used to control air conditioning or heating (not illustrated) and the illuminants 147 can also be used for signaling like the lamp 21 and can be used additionally also for normal illumination of the room 11. The functional units 39, 41 are also randomly combinable with each other with different functions e.g. individually useable and mechanically and data connectable with the adapter 35.

The mini server 37 does not only control the functional units 39, 41 but also reads out the parameters of the smoke detector 31 and of the functional units 39, 41.

With respect to the mechanically interconnected configuration of the two functional units 39, 41 it is evident from FIGS. 2A and 2B that each functional unit 39, 41 is configured S-shaped in an axial direction with a protruding portion 39a, 41a and a recessed portion 39b, 41b, wherein the recess portions 39b, 41b of a functional unit 39, 41 are respectively enveloped by the protruding portion 41a, 39a of the other functional unit 39, 41.

It is furthermore evident from FIG. 2B that the functional units 39, 41 respectively include a plurality of functional elements, illuminant 147, module for capturing audio and video signals 149, motion detector 151, temperature sensor 153 which are respectively arranged in an alternating manner in order to achieve optimum functional distribution.

The adapter 35 furthermore includes an external voltage supply (not illustrated) which also feeds the mini server 37 so that no energy is drawn from the battery 155 of the smoke detector 31. In this context a control is helpful where the smoke detector 31 is supplied with energy through the conductor 157 through the external power supply of the adapter 35 and power is only supplied from the actual battery 155 when network power fails. This substantially increases safety since the battery is loaded less.

The conductor 157 for the energy supply and the communication cable 34 are run through a cable pass through 159.

It is evident that communications between the smoke detector 31 and the adapter 35 are provided through the communication interface 33 of the smoke detector 31, the communication cable 34 and the communication interface 36 of the adapter 35. Alternatively the communication cable 34 can also be omitted and the two communication interfaces 33, 36 are uniformly implemented as plug interfaces. However, the embodiment with the communication cable 34 is preferred since for each smoke detector type 31 which includes a proprietary communication interface 33 only one proprietary communication cable 34 has to be provided and the adapter 35 itself can remain unchanged.

The mini server 37 is adapted to collect and process information from the connected household appliances 17, 21, 25, the smoke detector 31 and the functional units 39, 41 and can forward this information to a second control and/or processing device (not illustrated) which is provided for example as an IPad®. Simultaneously the mini-server 37 is configured so that it is programmable through the second control and/or processing device.

When nothing else is stated all features of the instant invention are randomly combinable with each other. Also the features described in the figure description are features of the invention and are randomly combinable with the other features unless stated differently. Thus, device features can also be used as method features and method features can also be used as device features.

### REFERENCE NUMERALS AND DESIGNATIONS

1 budding automation system

3 building

5 bedroom

7 kitchen

9 garage

11 living room

12 bathroom

13 alarm clock

15 light restriction device, variable shutter

17 refrigerator

19 garage door

21 lamp

23 smoke detector unit

25 television set

27 presence detector

29 Fritz® box

31 smoke detector

32 room ceiling

33 communication interface

34 communication cable

35 adapter with device driver

36 communication interface

37 control and/or processing device, mini server

38 attachment of smoke detector 31 at adapter 35

39 functional unit

39a protruding portion of functional unit 39

39B recessed portion of functional unit 39

41 functional unit

41a protruding portion of functional unit 41

41b recessed portion of functional unit 41

143, 145 plug connections

147 illuminant

149 module for receiving audio and video signals

151 motion detector sensor

153 temperature sensor

155 battery

157 energy supply conductor

159 cable pass through

What is claimed is:

1. A system for building automation, the system comprising:
at least one smoke or fire detector including a connection side;
at least one adapter that is coupleable with the at least one smoke or fire detector and that includes a front side, a backside and a lateral portion connecting the front side and the backside; and
at least one functional unit which is connected or connectable with the at least one adapter,
wherein the at least one smoke or fire detector is arranged with the connection side on a front side of the at least one adapter and the at least one functional unit extends with respect to the connection side of the at least one smoke or fire detector below the at least one smoke or fire detector about the lateral portion of the at least one adapter in a connected condition of the at least one smoke or fire detector, the at least one adapter and the at least one functional unit, and
wherein the at least one smoke or fire detector, the at least one adapter and the at least one functional unit are mechanically connected in the connected condition of the at least one smoke or fire detector, the at least one adapter and the at least one functional unit.

2. The system according to claim 1, wherein the at least one functional unit is configured as a respective module.

3. The system according to claim 1, wherein the at least one functional unit implements at least one property from a group including motion detector, temperature sensor, video capture, audio capture, illumination, light sensor, humidity sensor, CO₂ sensor, CO sensor.

4. The system according to claim 1, further comprising:
a first control or processing device,
wherein the first control or processing device is provided as the at east one adapter, or
wherein the at least one adapter is provided as a communication device or a gateway.

5. The system according to claim 4,
wherein the first control or processing device controls the at least one smoke or fire detector or the at least one functional unit, or
wherein the first control or processing device reads out at least one parameter of the at least one smoke or fire detector or of the at least one functional unit.

6. The system according to claim 1, wherein at least one communication connection is provided with at least one piece of household equipment selected from a group including: coffee makers, vacuum cleaners, washers, dish cleaners, micro waves, water boilers, mixers, stove tops, stoves, refrigerators, freezers, television sets, music play back devices, motion detectors, illumination devices, air conditioners, fire places, bathroom equipment.

7. The system according to claim 1, further comprising:
a first control or processing device,
wherein the first control or processing device is provided as the at least one adapter, or
wherein the at least one adapter is provided as a communication device or a gateway, and
wherein the first control or processing device is configured to collect or process information from connected pieces of household equipment, the at least one smoke or fire detector or the at least one functional unit, or
forward the information to at least one second control or processing device.

8. The system according to claim 1, wherein the at least one functional unit is configured coupleable to a first control or processing device or the at least one adapter.

9. The system according to claim 1, wherein the at least one functional unit is configured circular ring shaped.

10. The system according to claim 1,
wherein plural functional units of the at least one functional unit are configured pluggable into each other, or
wherein the at least one functional unit includes a base element and modules implementing at least one property are pluggable into the base element.

11. The system according to claim 1,
wherein at least one first control or processing device is associated with a unique address in a communication network, and
wherein the unique address in the communication network is a MAC-address in an IP network.

12. The system according to claim 1,
wherein a first control or processing device includes a network interface configured to communicate with other network units including a second control or processing device,
wherein the network interface is based on at least one protocol from a group including Bluetooth, Wi-Fi, ZigBee, Z-Wave, Ethernet and WLAN.

13. The system according to claim 1,
wherein a first control or processing device or the at least one adapter is autonomously provided with energy by at least one energy supply from a group including battery, accumulator and solar module to implement a minimal mode to read at least one property of a connected device for monitoring the connected device and to forward errors to a predetermined error reporting unit, or
wherein a first control or processing device or the at least one adapter is provided with external energy to implement a maximum mode.

14. A method for building automation, comprising the step
coupling at least one smoke or fire detector that includes a connection side with at least one adapter that includes a front side, a backside and a lateral portion connecting the front side and the backside, so that the connection side of the at least one smoke or fire detector is arranged on the front side of the at least one adapter;
connecting the at least one functional unit with the at least one adapter so that the at least one functional unit extends with respect to the connection side of the at least one smoke or fire detector below the at least one smoke or fire detector about the lateral portion of the at least one adapter in a connected condition of the at least one functional unit, the at least one smoke or fire detector and the at least one adapter,
wherein the at least one functional unit, the at least one smoke or fire detector and the at least one adapter are mechanically connected in the connected condition of the at least one functional unit, the at least one smoke or fire detector and the at least one adapter.

15. The method according to claim 14, wherein the system according to claim 1 is used.
